(19) United States
(12) Patent Application Publication
(10) Pub. No.: US 2007/0295141 A1
(43) Pub. Date: Dec. 27, 2007

(54) Multi-Angle Steering Column Assembly

(75) Inventors: Landon N. Ball, North Augusta, SC (US); Anthony J. Sanville, Evans, GA (US); William N. Mosuch, Augusta, GA (US); Walton R. Jeffcoat, Augusta, GA (US); Albert G. Packard, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/620,775

(22) Filed: Jan. 8, 2007

Related U.S. Application Data
(60) Provisional application No. 60/744,465, filed on Apr. 7, 2006.

(51) Int. Cl. B62D 1/16; B62D 1/18

(52) U.S. Cl. 74/492; 280/775

(57) ABSTRACT

A steering column assembly attached to a frame of a vehicle includes a base rigidly attached to the frame. A bracket may be attached to the base. A steering column may be rigidly attached to the bracket. The bracket may attach to the base in a plurality of orientations. At least one angle may be defined in a first orientation between the steering column and the base. A correspondingly measured second angle may be defined in a second orientation between the steering column and the base. The first angle is distinct from the second angle.

### CROSS-REFERENCE TO RELATED APPLICATIONS

This application claims the benefit of U.S. Provisional Application No. 60/744,465 filed Apr. 7, 2006. The disclosure of the above application is incorporated herein by reference.

### FIELD

The present disclosure relates to a steering column assembly in a small utility vehicle.

### BACKGROUND

The statements in this section merely provide background information related to the present disclosure and may not constitute prior art. Small utility vehicles such as: golf cars, shuttle personnel carriers, refreshment vehicles, industrial utility vehicles, and/or trail utility vehicles have many uses. Such vehicles accommodate a wide range of different-sized drivers. This results in common component designs.

For example, a steering column assembly is designed so the steering wheel may be useable by a short driver and a tall driver. If mounted at a high-angle position, the short driver can have difficulty reaching the steering wheel. If mounted at a low-angle position, the tall driver's legs can restrict the bottom potion of the steering wheel. Therefore, the manufacturer designs a steering column assembly that compromises between a low-angle position preferred by the short driver, and a high-angle position preferred by the tall driver. This allows each driver to drive the small utility vehicle, but not in the most accommodating circumstances.

Including an adjustable steering column and/or seat can increase costs in a small utility vehicle due to additional parts. Additional parts can also increase the complexity of the small utility vehicle that can introduce additional failures. Component durability can also be sacrificed due to wearing of adjustable parts.

A manufacturer can design, develop and/or produce more than one type of small utility vehicle. In this case, the manufacturer can use a common steering column assembly design for various types of small utility vehicles to reduce costs. More specifically, a common steering column assembly design for different types of small utility vehicles may reduce the number of parts in production, factory floor space, and inventory. However, a common steering column assembly design may be difficult to incorporate when different types of small utility vehicles require different steering column positions.

### SUMMARY

A steering column assembly attached to a frame of a vehicle includes a base rigidly attached to the frame. A bracket may be attached to the base. A steering column may be rigidly attached to the bracket. The bracket may attach to the base in a plurality of orientations. At least one angle may be defined in a first orientation between the steering column and the base. A correspondingly measured second angle may be defined in a second orientation between the steering column and the base. The first angle is distinct from the second angle.

According to additional features, a non-orthogonal angle is created between the bracket and the steering column. The bracket may be rotatable about a central axis to a selected one of the plurality of orientations. The non-orthogonal angle may be along a longitudinal plane of the vehicle. The plurality of orientations may include a pair of orientations. A first angle may be provided when the bracket is in the first orientation and a correspondingly measured second angle may be provided when the bracket is in the second orientation. Rotating the bracket from one of the plurality of orientations through approximately 180 degrees yields a second orientation. According to another example, four orientations may be provided. Rotating the bracket from one of the plurality of orientations through approximately 90 degrees yields another of the plurality of orientations.

According to another example, a steering assembly may include a base and a bracket attached to the base in one of a pair of orientations. A steering column may form an angle with the bracket of other than 90 degrees. Threaded fasteners may be attached to the bracket to the base. The angle may be measured in a generally longitudinal plane of the vehicle. The bracket may rotate 180 degrees about a central axis of the steering column to traverse from a first orientation to a second orientation. The bracket may be formed of metal. The bracket and the steering column may be attached by a weld.

According to another example, a steering column assembly for a vehicle includes a bracket attachable to each of a plurality of bases, each base being attached to a different vehicle. A steering column may be rigidly attached to a bracket. The bracket may attach to each of the plurality of bases in a respective orientation. At least one angle between the bracket and the steering column for a first respective orientation varies from a correspondingly measured angle between the bracket and the steering column for a second respective orientation.

Further areas of applicability will become apparent from the detailed description provided hereinafter. It should be understood that the detailed description and specific examples, while indicating the preferred embodiment of the invention, are intended for purposes of illustration only and are not intended to limit the scope of the disclosure.

### BRIEF DESCRIPTION OF THE DRAWINGS

The present invention will become more fully understood from the detailed description and the accompanying drawings, wherein:

FIG. 1 is a perspective view of an exemplary golf car according to various embodiments;

FIG. 2 is a side view of the golf car frame, steering, and suspension according to various embodiments;

FIG. 3 is a cross section view of a multi-angle steering column assembly according to various embodiments;

FIG. 4 illustrates a bracket in a first orientation according to various embodiments;

FIG. 5 illustrates the bracket rotating from the first orientation to a second orientation according to various embodiments;

FIG. 6 illustrates the bracket in the second orientation according to various embodiments;

FIG. 7 illustrates a side view of the multi-angle steering column assembly in a first and second position according to various embodiments; and

FIG. 8 illustrates a side view of the multi angle steering column assembly in a first and second position according to alternate various embodiments.

### DETAILED DESCRIPTION

The following description is merely exemplary in nature and is in no way intended to limit the present disclosure, application, or uses. Throughout this specification, like reference numerals will be used to refer to like elements.

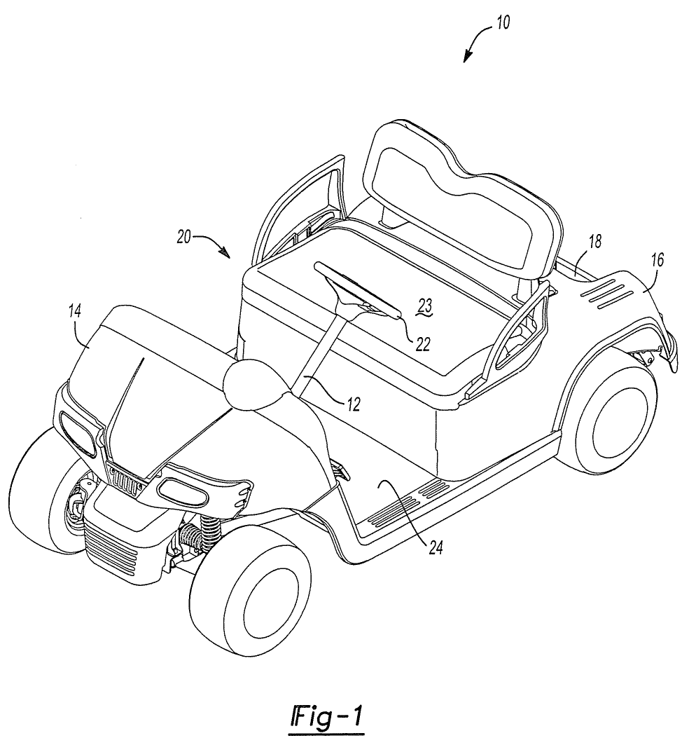

As seen in FIGS. 1-8, a multi-angle steering column assembly includes a bracket that is rigidly attached to a steering column. The bracket attaches to a base in more than one orientation allowing for more than one steering column position. This enables selection of a steering column position by selectively orienting the bracket. Furthermore, it allows the manufacturer to use a common part for different types of small utility vehicles.

Referring now to FIG. 1, in various embodiments, a golf car 10 includes a multi-angle steering column assembly 12. As will become appreciated, that the multi-angle steering column assembly 12 can be used with various golf car configurations. Furthermore, the multi-angle steering column assembly 12 is not limited for use with golf cars and can also be used with other small utility vehicles such as, but not limited to: shuttle personnel carriers, refreshment vehicles, industrial utility vehicles, and/or trail utility vehicles. The golf car 10 may include a front end 14, a rear end 16 having a golf bag storage area 18, and a passenger seating area 20. The seating area 20 may include a steering wheel 22, the multi-angle steering column assembly 12, a seat 23, and a floor portion 24.

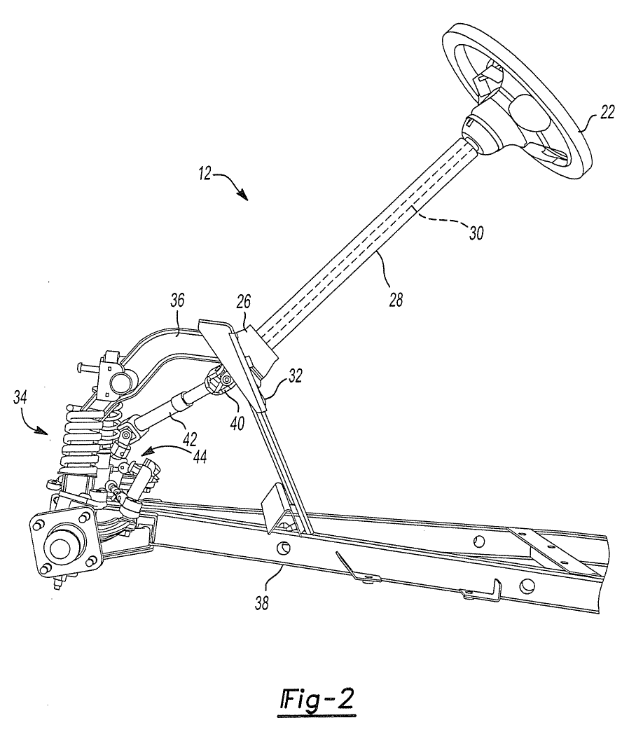

FIG. 2 depicts a side view of the frame, suspension, and driving system of the golf car 10. The multi-angle steering column assembly 12 may include a bracket 26, a steering column 28, a steering bar 30, and a base 32. In one example, the bracket 26 can be formed from a metal material. The bracket 26 may be rigidly attached to the steering column 28 by a weld such as a fillet weld. The bracket 26 may be attached non-orthogonally with the steering column 28. This allows for the orientation of the bracket 26 to create different positions for the steering column 28.

The steering bar 30 may be located within the steering column 28 and attached to a steering wheel 22 at one end. A frame 34 may include a top portion 36 and a bottom portion 38. The base 32 may be rigidly connected to the top portion 36. The base 32 can include an opening (not shown) through which the steering bar 30 passes. An end of the steering bar 30, opposite from the steering wheel 22, may attach to a u-joint 40. The u-joint 40 connects to a steering linkage 42 that transfers rotational motion from the steering bar 30 to a steering system 44. The steering system 44 may be, by way of non-limiting example, a rack and pinion system, a recirculating ball system, or a steering linkage system. The steering system 44 converts the rotational motion from the steering bar 30 to steer the golf car 10 accordingly.

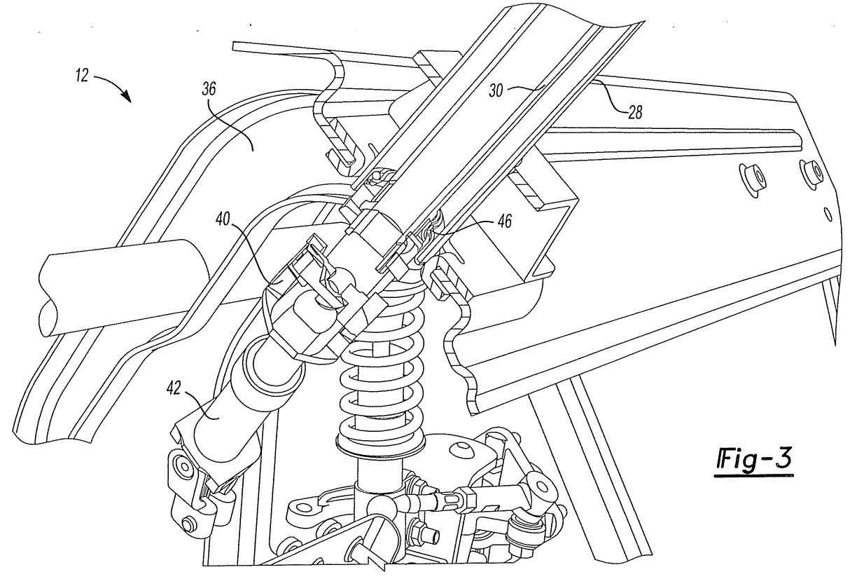

FIG. 3 further illustrates the multi-angle steering column assembly 12. The steering bar 30 may be generally centered in the middle of the steering column 28 by a bushing 46. The bushing 46 allows the steering bar 30 to rotate in a fixed position.

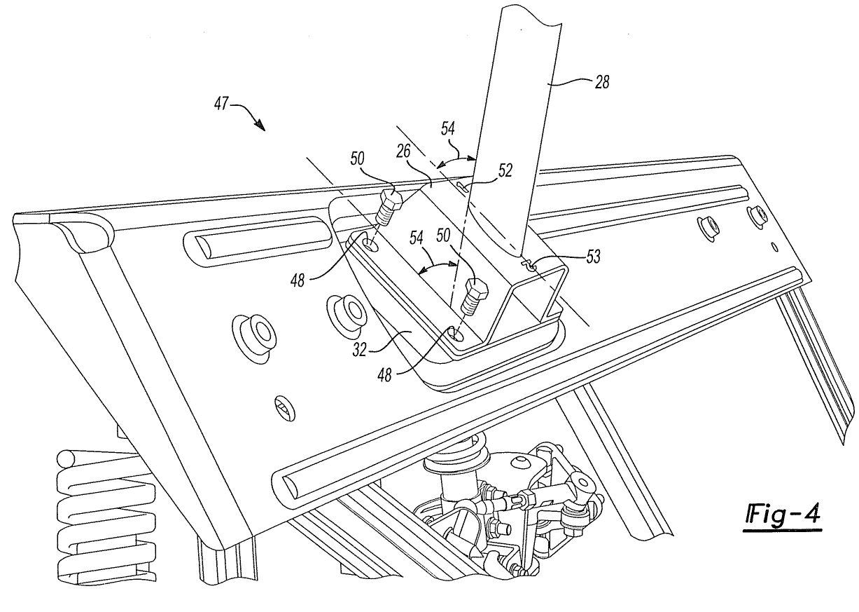

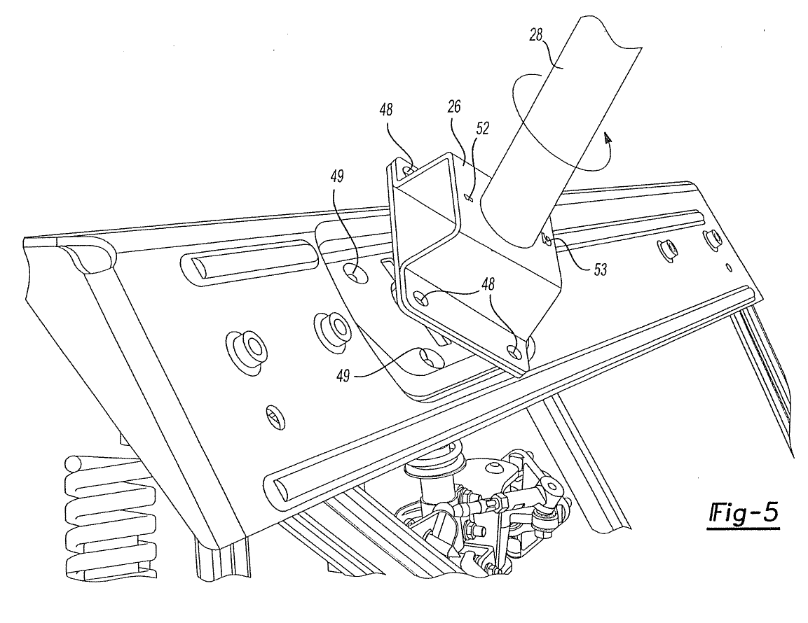

FIG. 4 depicts the bracket 26 in a first orientation 47. According to various embodiments, the steering column 28 can have two positions based on a selected orientation of the bracket 26. The bracket 26 may include apertures 48 located on a generally flat portion of the bracket 26. The apertures 48 align with base apertures 49, shown in FIG. 5, in the base 32. Fasteners 50 are placed through the bracket apertures 48 and the base apertures 49 to rigidly attach the bracket 26 to the base 32. Typically, the fasteners 50 are screw-type fasteners, but one skilled in the art will recognize other fastening arrangements can be utilized. The fasteners 50 enable removable insertion to change the orientation of the bracket 26.

First and second position markings 52, 53, respectively, are at selected locations on the bracket 26. According to the example shown, the first and second position markings 52 and 53 include the numerals “1” and “2”, respectively. It is appreciated that the position markings 52 and 53 may define other indicia or reference markings. According to various embodiments, a position marking oriented at the top of the bracket 26 in an installed position identifies a corresponding position of the steering column 28. As shown in FIG. 4, the first position marking 52 is on top, and therefore the bracket 26 is in the first orientation 47. A first angle 54 is defined between the steering column 28 and a planar face of the bracket 26. More specifically, the first angle 54 is defined between the portion of the bracket 26 that includes the first position marking 52 and the steering column 28. When the bracket 26 is parallel with the base 32, the first angle 54 can also be defined between the steering column 28 and the base 32.

According to various embodiments, the steering column 28 can be non-orthogonal with the base 32 only in a longitudinal plane of the golf car 10. This creates two distinct steering wheel heights for the golf car 10 when the bracket 26 is rotated 180 degrees about a fixed axis. Therefore, the end assembler has a preference between the two heights of the steering wheel 22. Manufacturers can also use the multi-angle steering assembly 12 as a common part in different types of small utility vehicles that require different steering wheel heights.

According to alternate various embodiments, the steering column 28 can be non-orthogonal with the base 32 only in a horizontal plane of the golf car 10. This allows for two distinct steering column positions in the horizontal plane when the bracket is rotated 180 degrees about a fixed axis. This allows the end assembler to choose between two steering wheel positions along the horizontal axis. In still other alternate various embodiments, the steering column 28 can be non-orthogonal with the base 32 in both the longitudinal and horizontal plane of the golf car 10.

It is appreciated that in some implementations, the bracket 26 may have more than two orientations. The number of orientations for the bracket 26 determines the number of steering column positions. For example, if the bracket 26 can only be oriented by rotating 180 degrees, then the steering column 28 will have two unique positions. If the bracket 26 can be oriented by rotating 90 degrees, then the steering column 28 will have four unique positions.

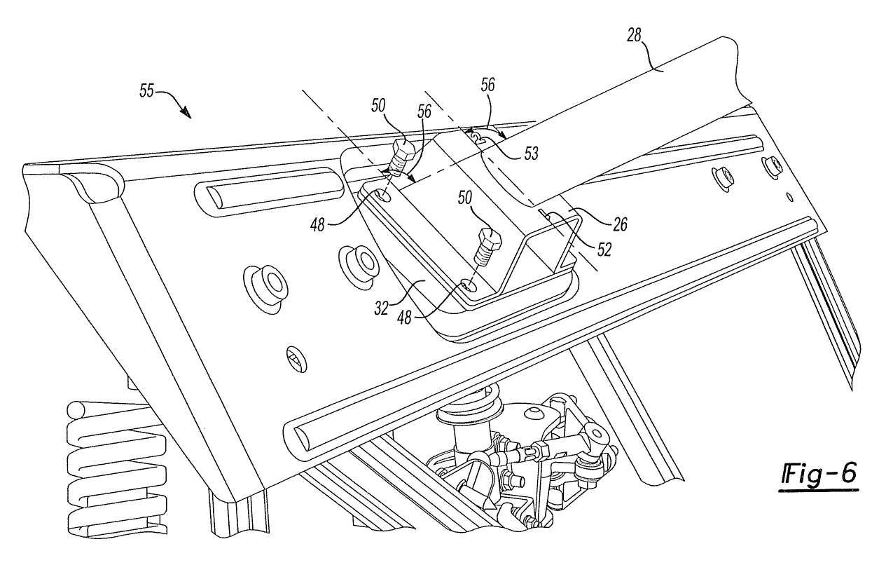

In FIG. 5, the bracket 26 is shown being rotated about a fixed axis to another orientation. In FIG. 6, the bracket 26 is shown secured in a second orientation 55. Fasteners 50 are placed through the bracket apertures 48 and the base apertures 49 to rigidly attach the bracket 26 to the base 32 in the second orientation 55.

The second position marking 53 identifies the second orientation 55 of the bracket 26 which corresponds to a distinct steering column position. A second angle 56 is defined between the steering column 28 and the bracket 26. More specifically, the second angle 56 is defined between the portion of the bracket 26 that includes the second position marking 53 and the steering column 28. When the bracket 26 is parallel with the base 32, the second angle 56 can also be defined between the steering column 28 and the base 32.

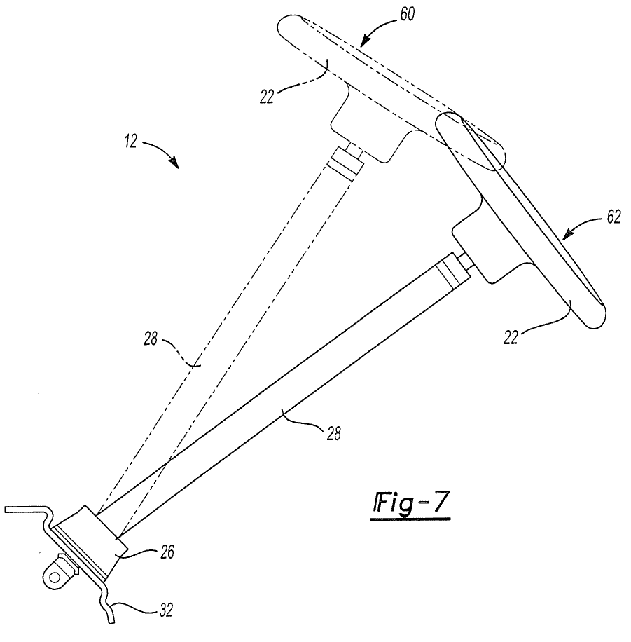

Referring now to FIG. 7, a side view of the steering column assembly 12 illustrates a first position 60 (shown in phantom) and a second position 62 of the steering column 28. The first position 60 corresponds to when the bracket 26 is in the first orientation 47. The second position 62 corresponds to when the bracket 26 is in the second orientation 55.

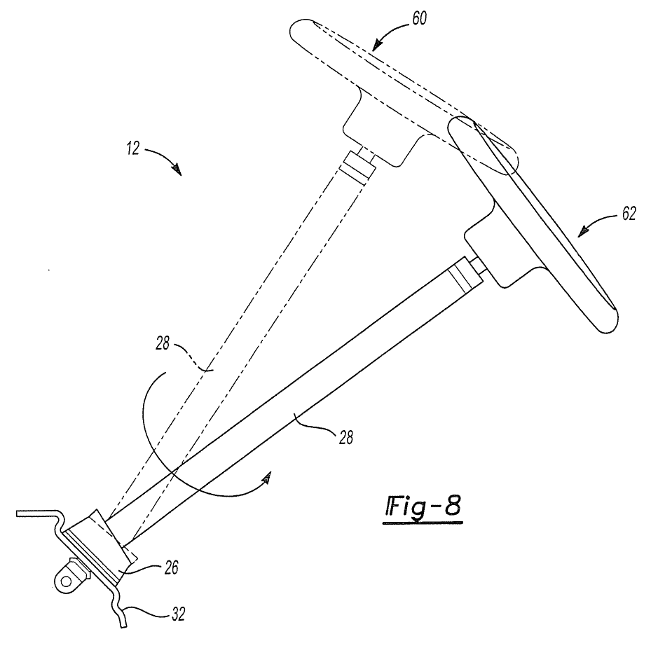

Referring now to FIG. 8, a side view of the steering column assembly 12 illustrates the first position 60 and the second position 62 of the steering column 28 according to alternate embodiments. The steering column 28 is orthogonal with the bracket 26. Since the top surface of the bracket 26 is not parallel with the base 32, a distinct angle between the steering column 28 and the base 32 for one orientation will be different from a correspondingly measured angle between the steering column 28 and the base 32 for another orientation. Therefore, first and second positions 60,62 can be achieved by orienting the bracket 26 when the steering column 28 is attached orthogonally to the bracket 26 provided the top surface of the bracket 26 is not parallel with the base 32.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A steering column assembly attached to a frame of a vehicle comprising:
a base rigidly attached to the frame;
a bracket attached to the base; and
a steering column rigidly attached to the bracket, wherein the bracket attaches to the base in a plurality of orientations, wherein at least one angle is defined in a first orientation between the steering column and the base and wherein a correspondingly measured second angle is defined in a second orientation between the steering column and the base, wherein the first angle is distinct from the second angle.

2. The steering column assembly of claim 1 wherein a non-orthogonal angle is created between the bracket and the steering column.

3. The steering column assembly of claim 2 wherein the bracket is rotatable about a central axis to a selected one of the plurality of orientations.

4. The steering column assembly of claim 3 wherein the non-orthogonal angle is generally along a longitudinal plane of the vehicle.

5. The steering column assembly of claim 4 wherein the plurality of orientations includes a pair of orientations.

6. The steering column assembly of claim 5 wherein a first angle is provided when the bracket is in the first orientation, and a correspondingly measured second angle is provided when the bracket is in the second orientation.

7. The steering column assembly of claim 6 wherein rotating the bracket from one of the plurality of orientations through approximately 180 degrees yields a second of the plurality of orientations.

8. The steering column assembly of claim 4 wherein the plurality of orientations includes four orientations.

9. The steering column assembly of claim 8 wherein rotating the bracket from one of the plurality of orientations through approximately 90 degrees yields another of the plurality of orientations.

10. A steering assembly comprising:
a base;
a bracket attached to the base in one of a pair of orientations; and
a steering column rigidly attached to the bracket, wherein the steering column forms an angle with the bracket of other than 90 degrees.

11. The bracket assembly of claim 10 wherein threaded fasteners attach the bracket to the base.

12. The bracket assembly of claim 11 wherein the angle is measured in a generally longitudinal plane of the vehicle.

13. The bracket assembly of claim 12 wherein the bracket rotates 180 degrees generally about a central axis of the steering column to traverse from a first orientation to a second orientation.

14. The bracket assembly of claim 13 wherein the bracket is formed of metal.

15. The bracket assembly of claim 14 wherein the bracket and the steering column are attached by a weld.

16. A steering column assembly for a vehicle comprising:
a bracket attachable to each of a plurality of bases, each base being attached to a different vehicle; and
a steering column rigidly attached to the bracket,
wherein the bracket attaches to each of the plurality of bases in a respective orientation, and at least one angle between the bracket and the steering column for a first respective orientation varies from a correspondingly measured angle between the bracket and the steering column for a second respective orientation.
